(19) United States
(12) Patent Application Publication
(10) Pub. No.: US 2025/0252270 A1
(43) Pub. Date: Aug. 7, 2025

(54) GENERATION OF SOURCE-BASED CONFIDENCE SCORE FOR LLM OUTPUT

(71) Applicant: Wells Fargo Bank, N.A., San Francisco, CA (US)

(72) Inventors: Naga Jyothi Avusingi, Hyderabad (IN); Anjeet Kumar, Bangalore (IN); Rameshchandra Bhaskar Ketharaju, Hyderabad (IN); Parul Ghosh, Bangalore (IN)

(21) Appl. No.: 18/433,100

(22) Filed: Feb. 5, 2024

(51) Int. Cl. G06F 40/40

(52) U.S. Cl. CPC G06F 40/40

(57) ABSTRACT

A computing system may be configured for generating a source-based confidence score in association with output from a Large Language Model (LLM). The computing system may obtain computer-generated text output from the LLM as an answer to an inquiry submitted by a computing device. The computing system may determine a confidence score in association with the answer to the inquiry based on an evaluation of one or more sources used by the LLM to generate the answer and determine whether the confidence score associated with the answer satisfies a quality threshold. Based on the confidence score associated with the answer satisfying the quality threshold, the computing system may generate an annotated answer including the answer and an indication of quality based on the evaluation of the one or more sources used by the LLM to generate the answer. The annotated answer may be output in response to the inquiry.

### TECHNICAL FIELD

This disclosure relates to data platforms for computing systems, and more particularly to a data platform for use with large language models (LLMs).

### BACKGROUND

Large pre-trained Transformer language models, or simply large language models (LLMs), generate text from a corpus of source materials in response to user input queries known as “prompts.” Trained LLMs may provide computer-generated output as answers in response to a user question or prompt, however, such computer-generated output may provide low-quality output including, obsolete answers, misleading answers, and/or inaccurate answers. In certain situations, trained LLMs are known to provide seemingly made-up information provided as factual information, sometimes referred to as a “hallucination” by the trained LLM. Hallucinations and other low-quality answers pose a serious problem for LLMs because they can lead to the spread of misinformation, expose confidential information, and create unrealistic expectations about the capabilities and benefits of trained LLMs.

Because LLMs are a type of artificial intelligence (AI) which are generally trained on massive datasets of text and code, they may learn to associate certain words or phrases with certain concepts, even if those associations are not accurate. These learned associations may lead to LLMs generating text that is factually incorrect, inadvertently overly indulgent, or simply nonsensical.

### SUMMARY

This disclosure describes a computing system configured to determine confidence scores for automatically generated text output of Large Language Models (LLMs) based on the source materials used by the LLMs to generate the output. The computing system may supplement and/or annotate the output of the LLMs (e.g., answers to inquiries entered as prompts) with additional context or supplemental information, such as indications of quality determined for the answers based on evaluations of the sources used to generate the answers.

According to the disclosed techniques, processing circuitry of the computing system may execute a meta layer interface configured to obtain computer-generated text (e.g., an answer) provided by an LLM in response to an inquiry or prompt before the answer is returned to a user computing device that submitted the inquiry. In such an example, the meta layer interface may supplement and/or annotate the answer to generate an annotated answer in response to the inquiry. The computing system then outputs the supplemented and/or annotated answer for display to the user computing device.

In some examples, the computing system provides an annotated answer having, by way of example, citations to sources utilized by the LLM in generating the answer. In other examples, the computing system supplements an answer with a numerical score or a non-numeric grade, providing an indication as to the quality or trustworthiness of the answer provided. In certain examples, the computing system implements systemic safeguards that withhold an automatically generated answer due various assessments, such as lack of appropriateness of the answer generated, lack of quality or trustworthiness for the answer provided, or use of invalidated or un-trustworthy sources by the LLM to generate the answer. Such a computing system may provide as output to the user computing device, an indication the answer was withheld and optionally request the user to re-submit the inquiry to the LLM to generate a new answer. In other examples, the system may automatically re-submit a previously submitted inquiry on behalf of the originator of the inquiry to cause the LLM to generate a new answer when an initial answer is withheld from the user by the meta layer interface.

The disclosed techniques may provide one or more technical advantages and practical applications. For example, disclosed techniques include a mechanism by which to improve the LLM based on user feedback. For instance, a computing system may obtain user feedback regarding the quality and/or helpfulness of an answer provided by the LLM. Such user feedback may be utilized to update the LLM, enabling the LLM to provide higher quality answers in the future. In other examples, the computing system annotates answers generated by the LLM with an indication of quality, such as annotations regarding the trustworthiness of citations and/or sources relied upon by the LLM in generating the answer. In certain examples, the computing system may determine that an answer provided by the LLM fails to satisfy a quality threshold and responsively institutes systemic controls to prevent such a low-quality answer from reaching a user and/or being provided as an answer to a user inquiry. For instance, the computing system may obtain a confidence score providing a quantitative measure of quality for an answer provided by the LLM and compare the confidence score against a quality threshold. When the answer fails to satisfy the quality threshold, the computing system may discard the answer entirely, thus preventing the answer from being returned to the user. Alternatively, the computing system may automatically re-submit the original inquiry to the LLM and obtain a new answer from the LLM for the original inquiry, in an attempt to obtain a better and higher quality answer. In such examples, the new answer may once again be evaluated for quality, and if the new answer satisfies the quality threshold, then the new answer may be annotated and provided as output for display to a user with annotations indicating a measure of quality based on the evaluation by the computing system.

According to one example, a system includes one or more storage devices and processing circuitry in communication with the one or more storage devices configured to perform operations. For instance, processing circuitry of the system may be configured to obtain computer-generated text output from a Large Language Model (LLM) as an answer to an inquiry submitted by a computing device. In such an example, processing circuitry may determine a confidence score in association with the answer to the inquiry based on an evaluation of one or more sources used by the LLM to generate the answer and determine whether the confidence score associated with the answer satisfies a quality threshold. According to at least one example, processing circuitry, based on the confidence score associated with the answer satisfying the quality threshold, may be configured to generate an annotated answer including the answer and an indication of quality based on the evaluation of the one or more sources used by the LLM to generate the answer. In such an example, processing circuitry may output, to the computing device, the annotated answer in response to the inquiry.

In some examples, a disclosed method includes operations in support of the one or more techniques described herein. According to such an example, the method includes obtaining, by processing circuitry of a computing system, computer-generated text output from a Large Language Model (LLM) as an answer to an inquiry submitted by a computing device. The method may determine, by the processing circuitry, a confidence score in association with the answer to the inquiry based on an evaluation of one or more sources used by the LLM to generate the answer. Continuing with such an example, the method may determine, by the processing circuitry, whether the confidence score associated with the answer satisfies a quality threshold. Based on the confidence score associated with the answer satisfying the quality threshold, the method may generate, by the processing circuitry, an annotated answer including the answer and an indication of quality based on the evaluation of the one or more sources used by the LLM to generate the answer. According to such an example, the method may output, by the processing circuitry and for display to the computing device, the annotated answer in response to the inquiry.

In some examples, computer-readable storage media includes instructions that, when executed, configure processing circuitry to perform operations in support of the one or more techniques described herein. In some examples, the instructions, when executed, configure processing circuitry to obtain computer-generated text output from a Large Language Model (LLM) as an answer to an inquiry submitted by a computing device. The instructions may configure processing circuitry to determine a confidence score in association with the answer to the inquiry based on an evaluation of one or more sources used by the LLM to generate the answer and determine whether the confidence score associated with the answer satisfies a quality threshold. Based on the confidence score associated with the answer satisfying the quality threshold, the instructions may configure the processing circuitry to generate an annotated answer including the answer and an indication of quality based on the evaluation of the one or more sources used by the LLM to generate the answer. Continuing with such an example, the instructions may configure processing circuitry to output, to the computing device, the annotated answer in response to the inquiry.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIGS. 1A and 1B are block diagrams illustrating example network systems, each including a computing system having a meta layer interface configured to generate source-based confidence scores for LLM output, in accordance with one or more aspects of the present disclosure.

FIG. 2 is a block diagram illustrating another example network system including a computing system having a validator configured to evaluate one or more sources used by an LLM to generate answers, in accordance with one or more aspects of the present disclosure.

FIG. 3 is a block diagram illustrating an example computing system configured to generate source-based confidence scores for LLM output, in accordance with one or more aspects of the present disclosure.

FIG. 4 is a flow chart illustrating an example mode of operation for a computing system to generate source-based confidence scores to annotate output of LLMs, in accordance with techniques of this disclosure.

Like reference characters denote like elements throughout the text and figures.

### DETAILED DESCRIPTION

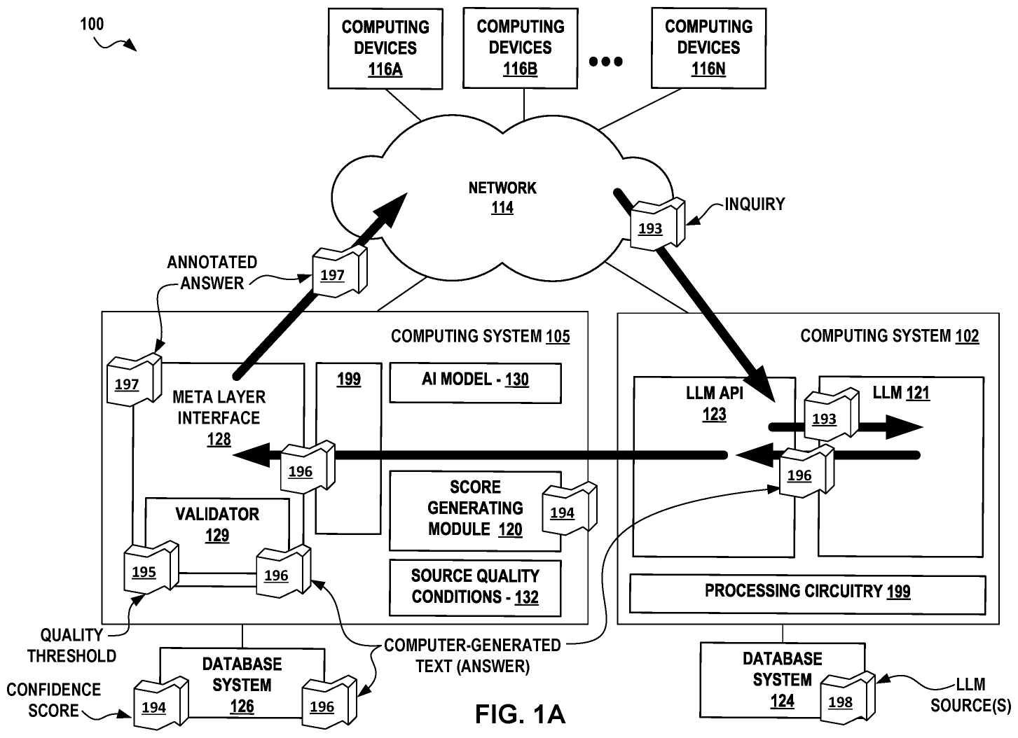

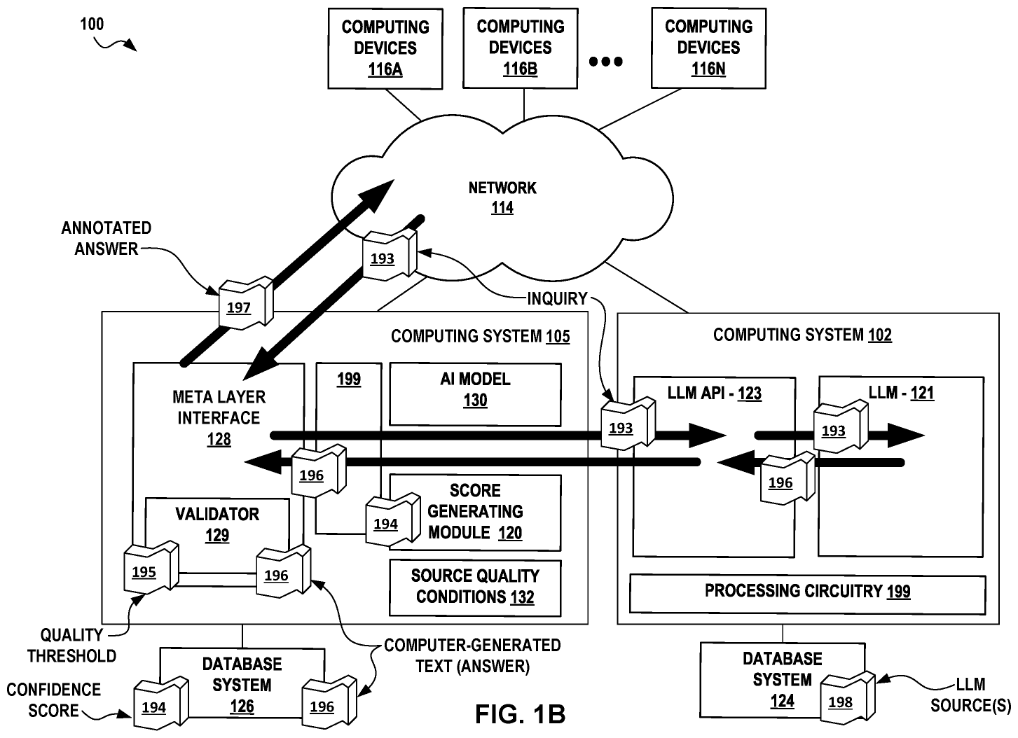

FIGS. 1A and 1B are block diagram illustrating example network systems, each 100 including computing system 105 having meta layer interface 128 configured to generate source-based confidence scores 194 for LLM output, in accordance with one or more aspects of the present disclosure. In the example of FIGS. 1A-1B, network system 100 includes multiple computing systems 102 and 105 communicably interfaced with network 114. Network 114 may be interfaced with multiple computing devices 116, such as user computing devices, including computing devices 116A, 116B, through 116N, collectively referred to as computing device(s) 116.

Computing devices 116 may submit inquiries 193 to Large Language Model 121 (LLM 121) of computing system 105. For example, computing devices 116 may submit inquiry 193 to LLM 121 using LLM Application Programming Interface (LLM API) 123. In some examples, inquiries 193 are submitted by computing devices 116 directly to computing device 102, with such inquiries effectively bypassing meta layer interface 128 entirely, such as the path of inquiry 193 at FIG. 1A. However, in alternative configurations, meta layer interface 128 of computing system 105 may optionally be utilized to receive and/or route inquiries 193 from computing devices 116 to LLM 121 of computing system 102, such as the path of inquiry 193 at FIG. 1B. In some examples, meta layer interface 128 may receive inquiry 193 from computing devices 116 and submit inquiry 193 to LLM 121. In other examples, meta layer interface 128 may receive an original answer 196 output from LLM 121 in response to inquiry 193 and re-submit inquiry 193 to LLM 121 to generate a new answer 196. In further examples, meta layer interface 128 may cache inquiries 193 received from computing devices 116 and cache answers 196 received from LLM 121 in database system 126 to avoid later re-submission of identical or similar inquiries to LLM 121.

In the example of FIGS. 1A-1B, meta layer interface 128 may coordinate evaluation of answers 196 returned by LLM 121 using various interconnected subcomponents of computing system 105. For instance, computing system 105 includes meta layer interface 128 communicably interfaced with each of validator 129, score generating module 120, and artificial intelligence model (AI model) 130. Meta layer interface 128 may utilize score generating module 120 to create quantitative confidence scores 194 for answers 196 returned by LLM 121. Score generating module 120 may request confidence score 194 from AI model 130 or modify calculated confidence scores 194 based on predictive output generated by AI model 130. Meta layer interface 128 may request qualitative evaluation of an answer 196 returned by LLM 121 using validator 129. For instance, validator 129 may evaluate LLM sources 198 based on source quality conditions 132. Validator 129 may optionally provide both qualitative validation and quantitative validation of an answer 196 returned by LLM, for instance, by comparing confidence score 194 returned by score generating module 120 against quality threshold 195.

In some examples, meta layer interface 128 coordinates obtaining and annotating answers 196 provided by LLM 121. In other examples, meta layer interface 128 may coordinate the submission of inquiries 193 to LLM 121 or coordinate resubmission of previously received inquiries to LLM 121. For instance, in the example of FIGS. 1A-1B, computing system 105 is communicably interfaced with computing device 102 through network 114 and meta layer interface 128 may communicate with LLM 121 using an application programming interface (API) of computing device 102, such as LLM API 123. Computing device 102 may use LLM API 123 for interfacing with any of computing devices 116, computing system 105, or other network connected computing systems.

Computing system 102 may be communicably interfaced and/or networked with database system 124. Computing system 102 may use database system 124 to store and record information, such as storing a training dataset for AI model 130 and/or storing LLM sources 198 for LLM 121.

In the example of FIG. 1A, LLM 121 receives inquiries 193 from user computing devices 116 and generates answers 196 in response to such inquires 193. For instance, when computing device 116 submits inquiry 193 to computing system 102, LLM API 123 receives inquiry 193 from computing device 116 via network 114 and LLM API 123 provides inquiry 193 to LLM 121 as input. In such a way, LLM 121 may be configured to receive inquiry 193 without any involvement from meta layer interface 128. Conversely, in the example of FIG. 1B, inquiries 193 from user computing devices 116 are routed through meta layer interface 128 before being relayed to LLM 121. In such an example, computing device 116 in communication with meta layer interface 128 via 114 may generate inquiry 193 which is submitted to meta layer interface 128. Meta layer interface 128 may receive inquiry 193 from computing device 116 and relay inquiry 193 to LLM API 123 at computing system 102, with a request for LLM 121 to generate answer 196 in response to inquiry 193. Continuing with such an example, LLM API 123 passes inquiry 193 to LLM 121 and LLM 121 provides computer generated text (e.g., answer) 196 in reply to inquiry 193. LLM API 123 may receive answer 196 from LLM 121 and relay answer 196 back to meta layer interface 128 as a response to the request by meta layer interface 128 that LLM 121 generate answer 196 in response to inquiry 193.

Regardless of whether inquiry 193 is routed from computing device 116 to LLM 121 through meta layer interface 128 at computing system 105 or provided to LLM API 123 at computing system 102 without passing through meta layer interface 128, inquiry 193 represents some user question submitted via computing device 116. Inquiry 193 may take the form of a free-form text question asked by a user of computing device 116 seeking information. Responsive to receiving inquiry 193, LLM 121 produces as output, computer-generated text 196 constituting an “answer” 196 to inquiry 193 received by LLM 121. Note that element 196 as used herein represents both “computer-generated text 196” and “answer 196.” Subsequent to LLM 121 providing computer-generated text 196 as output responsive to inquiry 193, meta layer interface 128 of computing system 105 obtains, intercepts, or otherwise receives answer 196 from LLM 121 (e.g., via LLM API 123) prior to answer 196 being returned to whichever computing device 116 originated inquiry 193. For example, answer 196 may be written into database system 126 and retrieved by meta layer interface 128 from database 126 or answer 196 may be provided as input to meta layer interface 128 by LLM API 123.

Meta layer interface 128 coordinates analysis of answer 196 and generates annotated answer 197 as output to computing device 116 having originated inquiry 193. For instance, responsive to obtaining answer 196, meta layer interface 128 performs various operations to ensure answer 196 satisfies various quality criteria prior to permitting answer 196 to be returned to a user, thus providing a systemic function by which all answers 196 may be checked for sufficient quality. For instance, meta layer interface 128 may coordinate with validator 129 to evaluate whether sources utilized by LLM 121 are valid or coordinate with score generating module 120 to generate a numeric score which is compared with a threshold, or both.

In the example of FIGS. 1A-1B, computing system 105 includes validator 129 which is communicably interfaced with meta layer interface 128. In some examples, validator 129 evaluates computer-generated text (e.g., answer) 196 produced by LLM 121 to assess the quality of answer 196. For example, LLM 121 may provide as answer 196, computer-generated text 196 in reply to inquiry 193 from computing devices 116. In some examples, meta layer interface 128 obtains answer 196 and validator 129 evaluates answer 196 against quality threshold 195. In some examples, validator 129 may obtain confidence score 194 for a particular answer 196 from score generating module 120. In some examples, validator 129 compares confidence score 194 against quality threshold 195 to determine whether answer 196 provided by LLM 121 satisfies quality threshold 195.

Consider an example where LLM 121 utilizes sources 198 when providing computer-generated text 196 and provides citations to such sources 198. The mere act of LLM 121 providing citations to sources 198 does not necessarily mean that sources 198 cited are of sufficient quality. For instance, it may be that LLM 121 cites sources 198 but utilizes them improperly or out of context. In other examples, LLM 121 may cite source 198 which is part of a training dataset for LLM 121, and yet, the source 198 may no longer be valid at the time of the inquiry 193 or the source may have been superseded by more recent events and information. In some real-world examples, LLMs 121 have been proven to have “hallucinated” and crafted entirely fictitious sources 198 which form no part of any training data set, and yet, are referenced and cited as legitimate “sources” 198 by such LLMs (e.g., entirely non-existent court cases have been cited in support of LLM generated legal analysis and proven to be fictitious when subjected to scrutiny by human actors). Therefore, meta layer interface 128 may coordinate with validator 129 to validate such sources 198 prior to returning answer 196 to a user.

Meta layer interface 128 may coordinate the generation of confidence score 194 for use with validating answers 196 provided by LLM 121. In the example of FIGS. 1A-1B, computing system 105 includes score generating module 120 and AI model 130. In some examples, score generating module 120 computes confidence score 194. Score generating module 120 may obtain confidence score 194 and provide confidence score 194 to other components, such as validator 129, for use with evaluating the quality of computer-generated text 196. For instance, score generating module 120 may calculate and return a numeric value as a quantitative assessment of computer-generated text 196. In other examples, score generating module 120 may obtain confidence score 194 from AI model 130. For instance, AI model 130 may be configured to evaluate the quality of computer-generated text 196 provided by LLM 121.

In some examples, score generating module 120 coordinates with AI model 130 to produce confidence score 194. In such examples, AI model 130 receives as input, computer-generated text 196 and responsively generates confidence score 194. For instance, validator 129 may provide computer-generated text 196 as input to score generating module 120 on behalf of meta layer interface 128 and request confidence score 194 to be returned by score generating module 120 which utilizes AI model 130. In other examples, meta layer interface 128 or validator 129 may interact with AI model 130 directly to request a prediction of validity based on computer-generated text 196 provided as input. In certain examples, validator 129 coordinates all validation and evaluation of sources 198 and is responsible for obtaining confidence score 194 using score generating module 120 to generate confidence score 194. In such examples, score generating module 120 may utilize AI model 130 to generate confidence score 194 or score generating module 120 may apply additional weightings to confidence score 194 based on predictive output provided by AI model 130. Subsequent to generating or calculating confidence score 194, score generating module 120 writes confidence score 194 into database system 126 or provides confidence score 194 to validator 129 for use by validator 129 in determining whether computer-generated text 196 obtained from LLM 121 satisfies quality threshold 195.

Score generating module 120 may obtain a quantitative assessment from AI model 130 in the form of confidence score 194 at the request of metal layer interface 128. For instance, score generating module 120 may utilize AI model 130 to provide confidence score 194 based on input provided by score generating model 120. According to one example, score generating model 120 obtains confidence score 194 by providing as a first input to artificial intelligence model 130 (AI model 130), a golden copy of answers maintained by meta layer interface 128 and providing as a second input to AI model 130, computer-generated text 196 output from LLM 121 provided as answer 196 to inquiry 193. In such an example, AI model 130 generates confidence score 194 based on the inputs provided and returns confidence score 194 to score generating module 120. For instance, having provided the inputs to AI model 130, score generating module 120 may responsively obtain from AI model 130, confidence score 194 indicating a measure of probability that answer 196 is accurate. More particularly, a score between 0 and 1 may be returned by AI model 130, with 0 indicating no confidence in the accuracy of answer 196 and 1 indicating the highest degree of confidence in the accuracy of answer 196. Alternatively, AI model 130 may return a weight or transferrable weights indicating a measure of confidence in the accuracy of answer 196 provided. In such examples where weights are returned by AI model 130, score generating module 120 may apply such weights to increase or decrease a previously obtained confidence score 194 for answer 196 being evaluated. Application of weightings by score generating module 120 to confidence score 194 may enable score generating module 120 to combine both AI module 130 output with human curated source quality conditions 132 or other configurable parameters provided to score generating module 120 which are not considered by AI model 130.

Validator 129 enables analysis of answers 196 returned by LLM 121 on behalf of meta layer interface 128. For instance, validator 129 may determine whether answer 196 or sources 198 utilized by LLM 121 in support of generated answer 196 pass or fail validation based on information output by score generating module 120. For instance, validator 129 may receive as input, confidence score 194 from score generating module 120 and compare confidence score 194 with quality threshold 195 to determine validity or invalidity of answer 196. Validator 129 may operate wholly agnostic of whether or not score generating module 120 utilized AI model 130 to produce confidence score 194. In such an example, meta layer interface 128 may accept as input, a determination of validity or invalidity from validator 129 which determines validity or invalidity based at least in part on confidence score 194. In other examples, meta layer interface 128 may optionally apply additional validation criteria and/or apply additional weightings to the determination of validity or invalidity provided by validator 129.

When answer 196 is determined to be invalid or fails to satisfy quality threshold 195, meta layer interface 128 may discard answer 196 entirely. When answer 196 is discarded, meta layer interface 128 may re-submit inquiry 193 back to LLM 121 to have LLM 121 generate another answer 196 (e.g., new answer 196). Alternatively, meta layer interface 128 may output a request to computing device 116 having generated inquiry 193 indicating answer 196 will not be provided. Meta layer interface 128 may separately indicate to computing device 116 that inquiry 193 should be either re-submitted or re-phrased and resubmitted. In certain examples, meta layer interface 128 may resubmit inquiry 193 on behalf of computing device 116 to generate new answer 196 without outputting any indication to computing device 116. For example, when answer 196 is determined to be invalid, rather than discarding answer 196 and notifying computing device 116 that no answer will be provided, meta layer interface 128 may resubmit answer 196 to generate new answer 196 and check whether or not new answer 196 satisfies validation criteria.

When answer 196 satisfies quality threshold 195, meta layer interface 128 annotates answer 196 to generate annotated answer 197 before ultimately returning annotated answer 197 to computing device 116 having originated inquiry 193. For instance, prior to returning answer 196 to a user of computing device 116, meta layer interface 128 may annotate answer 196 to generate annotated answer 197, providing additional information and context. Meta layer interface 128 may then output annotated answer 197 to computing device 116 for display. In such a way, meta layer interface 128 facilitates the receipt and processing of computer-generated text 196 provided by LLM 121 responsive to inquiry 193 and provides a systemic mechanism by which to validate information returned to a user satisfies at least some quality threshold 195. Annotations to answer 196 result in the formation of annotated answer 197 and provide additional context and beneficial information to a user regarding the computer-generated text 196 provided by LLM 121. Such context may include confidence score 194, indications regarding validity of individual sources 198 utilized by LLM 121 in creation of answer 196, and/or information derived from a user profile associated with computing device 116 having submitted inquiry 193.

Database system 126 may be communicably interfaced with computing system 105 to provide archival and retrieval functions on behalf of meta layer interface 128. In the example of FIGS. 1A-1B, database system 126 is communicably interfaced with computing system 105 and may store and/or record information including generated confidence scores 194, inquiries 193, and/or answers 196 obtained by meta layer interface 128. Computing system 105 may include source quality conditions 132 used by validator 129, AI model 130, and/or score generating module 120 to assess the quality of answer 196. In some examples, score generating module 120 generates confidence score 194 based on source quality conditions 132.

In some examples, LLM 121 outputs answers 196 into database system 124 communicably interfaced with computing system 102. Database system 124 may be a Structured Query Language (SQL) database or other type of storage. Score generating module 120 may output confidence scores 194 to database system 126 communicably interfaced with computing system 105. Database systems 124, 126 may associate or record as associations, related information, such as inquiry 193 associated with computer-generated text 196 (e.g., answer 196), a validation outcome for answer 196, a confidence score 194 for answer 196, and/or LLM source(s) 198 for answer 196. Information may be stored by database systems 124, 126 using a variety of file types and structures, including, by way of example, a comma-separated values (CSV) type file.

As described herein, LLM models (e.g., LLM 121) may be trained to output computer-generated text 196 as answers to questions (e.g., as responsive output to prompts received as input). Such models are sometimes referred to as “generative AI” models. Such generative AI models may be trained specifically as Large Language Models (LLMs), with such pretrained variants including “Generative Pre-trained Transformer” or “GPT” model variants GPT-1, GPT-2, GPT-3, and GPT-4. Other types of non-LLM models exist as well as less common interim LLM type GPT variants.

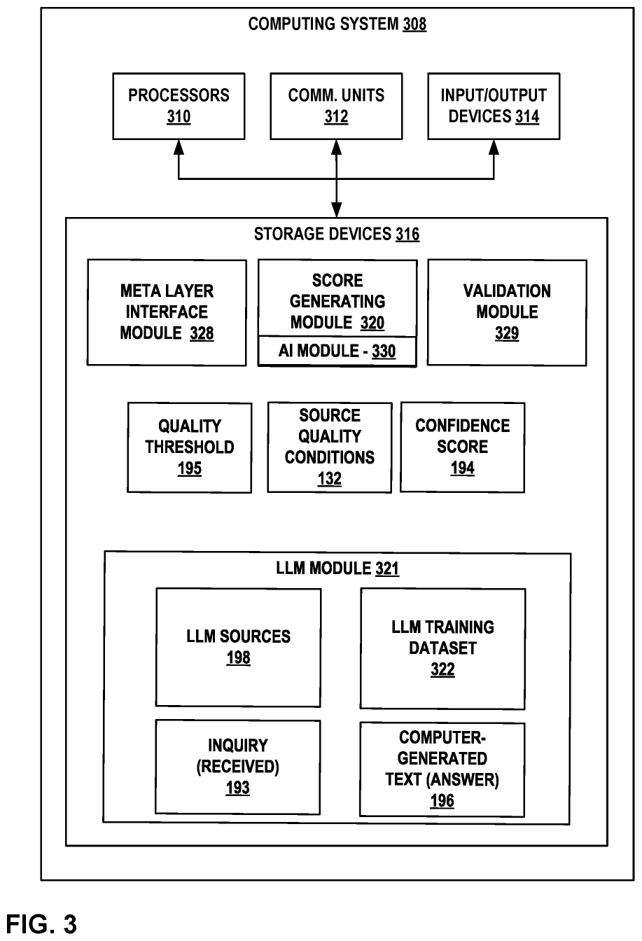

LLM 121 may be trained using historical data, forming, in essence, a snapshot in time of the knowledge from which LLM 121 trained. Because the process of training LLM 121 (sometimes referred to as “pre-training”) is lengthy and computationally intensive, previously LLM 121 may operate entirely oblivious as to information and events which are not represented within any training dataset(s) (e.g., see LLM training dataset 322 at FIG. 3) utilized in the training of LLM 121. Consequently, new information and events which occur between building the model variant and outputting generative text in the form of answer 196 or a response from LLM 121, regardless of the variant of LLM 121, may lack complete data. Stated differently, any information or events having occurred subsequent to the creation of a training data set upon which LLM 121 is trained is unknown to LLM 121, and as such, forms no part of any answer generated by LLM 121.

Moreover, LLM 121 may lack information upon which to assess the quality or confidence of the response to quantitatively score or otherwise validate that the response output by LLM 121 is correct, high quality, and/or authentic. Consider for example, LLM 121 having been trained on a corpus of text downloaded from a social media platform may generate text-based answers in reply to questions and/or “prompts.” However, the generation of answer 196 does not necessarily equate with that generated answer being correct, high quality, or even appropriate for the user having submitted inquiry 193. In the same way that low-quality, false, and/or biased information is accessible to users on the public Internet, the same information may be inadvertently provided to LLM 121 as part of a training dataset. Consequently, associations may be learned by LLM 121 which incorporate the low-quality, false, and/or biased information, resulting in such similar information later being provided as computer-generated output as answer 196 in response to inquiry 193. Effectively, the computer-age mantra of “garbage in, garbage out,” remains as true today in the era of artificial intelligence as it was in the early days of digital computing.

As mentioned above, when LLM 121 returns low-quality generative output as answer 196 to a prompt, there is no indication provided to user computing device 116 that the information provided should not be relied upon, and there are similarly no systematic checks instituted by such LLMs to prevent LLM 121 from outputting low-quality information to a user computing device 116. Generally, LLM 121 will provide as output computer-generated text 196 assessed as responsive to inquiry 193 based upon the training dataset for LLM 121, without regard to whether such information is valid. A systemic mechanism of implementing safeguards is needed.

Aspects of the disclosure provide meta layer interface 128, which is configured to institute various quality validation operations on answers 196 provided by LLM 121. For example, meta layer interface 128 may evaluate timeliness of information provided by LLM 121 by checking whether sources 198 utilized by LLM 121 to generate answer 196 are excessively outdated. In some examples, meta layer interface 128 evaluates data relevance by checking whether sources 198 utilized by LLM 121 are contextually relevant to the classification or category of the question presented by inquiry 193. In some examples, meta layer interface 128 may evaluate data authenticity by checking whether sources 198 utilized by LLM 121 correspond to valid URL and/or DNS information. In some examples, meta layer interface 128 evaluates source trustworthiness by checking whether sources 198 utilized by LLM 121 appear on a whitelist and/or blacklist. For instance, sources derived from university research and university publications may be scored higher and more trustworthy than sources 198 derived from social media platforms and social media posts.

Aspects of the disclosure include using meta layer interface 128 for determining whether text output is consistent with source content, for instance, by comparing the contents of answer 196 by LLM 121 with text, audio, and/or video of source 198 utilized by LLM 121. Meta layer interface 128 may generate at least one confidence score 194 as a quantitative assessment of answers 196 output by LLM 121 based at least in part on verification of one or more sources 198 used to generate answers 196. In some examples, meta layer interface 128 may be configured to generate annotations for inclusion in answers 196 output by LLM 121. For instance, meta layer interface 128 may annotate answer 196 provided as output by LLM 121 to generate annotated answer 197 indicating one or more portions of answer 196 originate from validated source content and/or correspond with confidence scores for one or more portions of answer 196 which satisfy quality threshold 195. For example, a source corresponding to a trusted medical journal may be annotated to indicate source validity as determined by meta layer interface 128 and other subcomponents of computing system 105.

In such a way, aspects of the disclosure utilizing meta layer interface 128 provide a solution to the problem of how much to trust the text generated by LLMs. For instance, meta layer interface 128 may output annotated answer 197 indicating a measure of quality based on the evaluation of one or more sources 198 used, permitting a user and/or consumer of such information to make a contextually relevant assessment of whether annotated answer 197 should be relied upon.

In the example of FIGS. 1A-1B, processing circuitry 199 is further depicted. According to one example, computing system 105 includes processing circuitry 199 configured to perform operations within computing system 105. For instance, in response to inquiry 193 from computing device 116 submitted to Large Language Model 121 (LLM 121), processing circuitry 199 of computing system 105 is configured to obtain, by meta layer interface 128, computer-generated text 196 output from LLM 121 as answer 196 to inquiry 193. In such an example, computing system 105 may determine confidence score 194 in association with answer 196 to inquiry 193 based on an evaluation of one or more sources 198 used by LLM 121 to generate answer 196. Meta layer interface 128 may annotate answers 196 to inquiries 193 to generate annotated answers 197 for output to computing device 116.

As illustrated in FIGS. 1A-1B, enterprise network 100 may include multiple computing systems 102, 105. Computing systems 102, 105 may be included in an enterprise network of an organization that includes a plurality of computing devices distributed across different geographical locations. Each of computing systems 102, 105 may be implemented at one or more data centers, each having multiple computing devices. Platforms, units, and modules illustrated in FIGS. 1A-1B are shown as being stored and/or executed at particular computing systems 102 or 105, but in other examples the platforms, units, and modules may be stored and/or executed according to different arrangements of computing systems 102, 105, such as within a single computing system, two computing systems, or across more than three computing systems.

Network 114 illustrated in FIGS. 1A-1B may include or represent any public or private communications network or other network. One or more client devices, server devices, or other devices may transmit and receive data, commands, control signals, and/or other information across such networks using any suitable communication techniques. In some examples, network 114 may be a separate network as illustrated in FIGS. 1A-1B, or one or more of such networks may be a subnetwork of another network. In other examples, two or more of such networks may be combined into a single network. Moreover, one or more such networks may be, or may be part of, or may be accessible to, the public Internet. Accordingly, one or more of the devices or systems illustrated in FIGS. 1A-1B may be in a remote location relative to one or more other illustrated devices or systems 102, 105. Network 114 illustrated in FIGS. 1A-1B may include one or more network hubs, network switches, network routers, network links, satellite dishes, or any other network equipment. Such devices or components may be operatively inter-coupled, thereby providing for the exchange of information between computers, devices, or other components (e.g., between one or more user devices or systems and one or more server devices or systems).

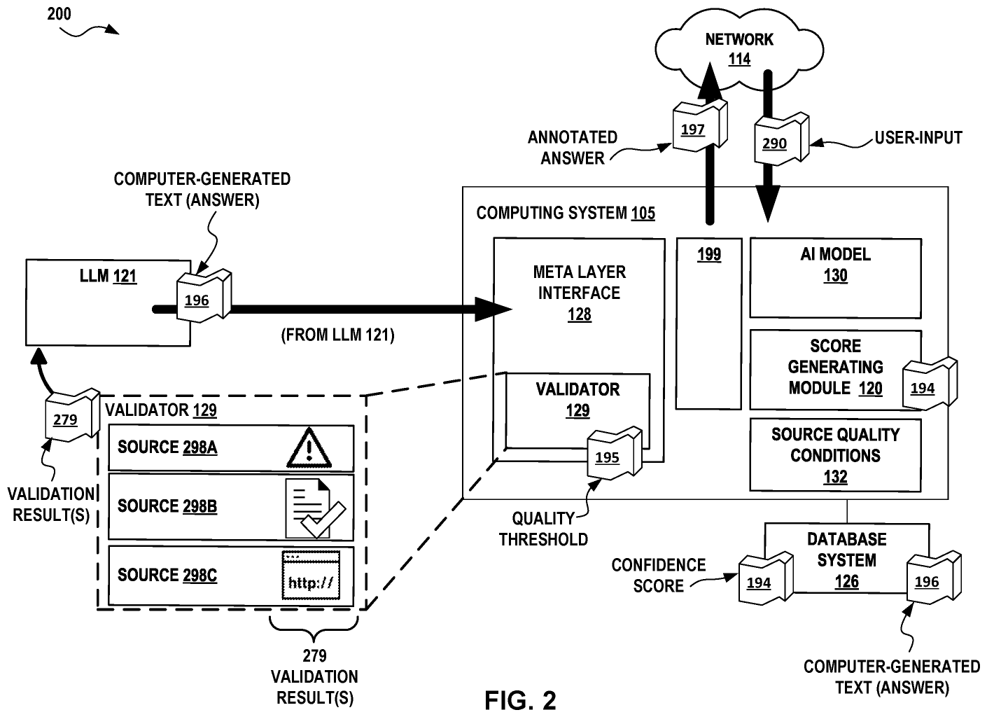

FIG. 2 is a block diagram illustrating another example network system 200 including computing system 105 having validator 129 configured to evaluate one or more sources 298A, 298B, 298C (collectively sources 298) used by LLM 121 to generate answers, in accordance with one or more aspects of the present disclosure.

In the example of FIG. 2, computing system 105 includes meta layer interface 128 which receives and/or obtains computer-generated text 196 as answer 196 to inquiry 193 from LLM 121. Computing system 105 is depicted as sending annotated answer 197 via network 114 and receiving user-input 290 via network 114. Meta layer interface 128 inter-operates with other modules including validator 129, AI model 130, score generating module 120, database system 126, and storage components, such as those which store source quality conditions 132.

Validator 129 is depicted in FIG. 2 as having evaluated each of source 298A, source 298B, and source 298C to produce validation results 279. In this example, each of sources 298 utilized by LLM 121 in support of answer 196 are subjected to validation by validator 129. In particular, source 298A is indicated as having a problem or an alert (e.g., as represented by the caution symbol), whereas source 298B is indicated as having been successfully validated (e.g., as represented by the check mark), and source 298C is depicted as validated or otherwise cross-checked against a live HTTP address to determine whether or not source 298C is valid or of sufficient quality.

In such an example, validator 129 evaluates each of source 298A, source 298B, and source 298C to generate validation results 279 as output. Validation results 279 may be utilized by validator 129 in determining validity or invalidity for each of sources 298 individually. Validator 129 may alternatively use validation results 279 in determining validity or invalidity for answer 196 as a whole. Validator 129 may provide validation results 279 as output to score generating module 120. Score generating module 120 may receive validation results 279 as input and provide validation results 279 to AI model 130 along with providing answer 196 for use in generating predictive output regarding the quality of answer 196.

In some examples, validator 129 of computing device 105 obtains confidence score 194 and validates computer-generated text 196 output from LLM 121 against one selected source, e.g., source 298B, from one or more sources 298 used by LLM 121 to generate answer 196. In some examples, validator 129 validates answer 196 using text obtained from selected source 298B and compared with computer-generated text 196 output from LLM 121. In some examples, validator 129 validates answer 196 using audio content obtained from selected source 298B and compared with computer-generated text 196 output from LLM 121. In some examples, validator 129 validates answer 196 using video content obtained from selected source 298B and compared with computer-generated text 196 output from LLM 121. In such examples, answer 196 provided by LLM 121 includes a listing of LLM sources 298. For example, consider a training dataset curated for LLM 121 upon which LLM 121 was trained. Regardless of when LLM 121 was trained, validator 129 may reference “live” information accessible to computing system 105 via network 114 and compare the live information with answer 196 provided by LLM 121.

In some cases, LLMs have been observed to “hallucinate” or provide entirely baseless information as part of answer 196. Such baseless information may be returned as factual by LLM 121 supported by one or more LLM sources 298. Accordingly, validator 129 may cross-check sources 298 provided by LLM 121 in support of answer 196 with live information accessible to validator 129. The live information may be from the source cited by LLM 121 or from different sources 298. In some examples, validator 129 is checking for consistency, timeliness, and authenticity of computer-generated text 196 against separate informational resources. In such a way, even in a circumstance where LLM 121 provides a baseless answer supported by one or more LLM sources 298, validator 129 may nevertheless cross-check and invalidate sources 298 directly (e.g., as non-existent and/or unacceptable trustworthiness) and/or invalidate sources 298 indirectly as inconsistent with live information provided by the source.

Consider a very simple example of inquiry 193 to LLM 121 asking: “Who is the president of the United States of America?” Depending on various factors such as the training dataset for LLM 121, when LLM 121 was last updated, and when the question is asked and answered by LLM 121, the identical answer could be 100% accurate or 100% inaccurate. Because large language models lack an informational basis for any event or new information having occurred subsequent to the training of LLM 121 (or outside of the training dataset utilized by LLM 121), LLM 121 may confidently return computer-generated text 196 as answer 196 in reply to inquiry 193 which is determinedly inaccurate. Validator 129 provides meta layer interface 128 with a mechanism by which to systematically assess the quality and validity of computer-generated text 196 returned by LLM 121 as answers without necessitating retraining of LLM 121.

According to aspects of the disclosure, meta layer interface 128 utilizes validator 129 to evaluate one or more sources 298 utilized by LLM 121 to generate answer 196 in response to inquiry 193. In some examples, meta layer interface 128 annotates answer 196 provided by LLM 121 generating annotated answer 197 to indicate some measure of quality, confidence, usefulness, and/or appropriateness. For instance, when annotated answer 197 is output to computing device 116 for display, the annotations may provide helpful indications to the user regarding the quality of computer-generated text 196 within annotated answer 197.

In some examples, validator 129 determines whether one or more sources 298 used by LLM 121 to generate answer 196 are valid sources 298. In another example, in response to a determination by validator 129, that one or more sources 298 used by LLM 121 to generate answer 196 are valid sources 298, validator 129 may provide validation results 279 as output to LLM 121 indicating validity or invalidity for each of one or more sources 298. For example, as depicted by FIG. 2, validator 129 provides validation results 279 to LLM 121 indicating validity or invalidity for each of one or more sources 298A, 298B, 298C. As depicted, source 298A is invalid, source 298B is valid, and source 298C is validated against a live http link and may therefore be valid or invalid depending upon when the http link is checked by validator 129. In examples where validator 129 outputs validation results 279 to LLM 121, such validation results 279 may be output to LLM 121 for use with reinforcement learning by LLM 121. For instance, LLM 121 may utilize validation results 279 to update and to generally improve the quality of future predictions and auto-generated text output provided as answers 196 to inquiries 193.

In some examples, validator 129 determines whether one or more sources 298 used by LLM 121 to generate answer 196 are valid sources 298 based on an evaluation of one or more source quality conditions 132. For instance, validator 129 may evaluate source quality conditions 132 may by determining whether any of one or more sources 298 are listed on a blacklist of sources 298. Evaluation of source quality conditions 132 may include determining whether any of one or more sources 298 are listed on a whitelist of sources 298. Evaluation of source quality conditions 132 may include determining whether any of one or more sources 298 correspond to deprecated source 298. Evaluation of source quality conditions 132 may include determining whether any of one or more sources 298 correspond to a curated list of untrustworthy URLs. Evaluation of source quality conditions 132 may include determining whether any of one or more sources 298 correspond to a curated list of trustworthy URLs. Evaluation of source quality conditions 132 may include determining whether any of one or more sources 298 are derived from university research. Evaluation of source quality conditions 132 may include determining whether any of one or more sources 298 are derived from a social media platform. Evaluation of source quality conditions 132 may include determining whether any of one or more sources 298 correspond to a social media post. Evaluation of source quality conditions 132 may include determining whether any of one or more sources 298 correspond to inauthentic DNS information for any of one or more sources 298. Evaluation of source quality conditions 132 may include determining whether any of one or more sources 298 correspond to inauthentic URL information for any of one or more sources 298. Evaluation of source quality conditions 132 may include determining whether any of one or more sources 298 have an excessive historical age. Evaluation of source quality conditions 132 may include comparing sources 298 or information from sources 298 to a golden copy of answers 196 maintained by meta interface layer 128.

In some examples, validator 129 performs an evaluation and/or an assessment of one or more sources 298 and meta layer interface 128 annotates answer 196 (to generate annotated answer 197) based on such an evaluation and/or assessment. Validator 129 may validate or invalidate each of one or more sources 298 and annotate answer 196 based on the validation to generate annotated answer 197. Consider for instance, validation of one or more sources 298 where one source is based on a social media posting and another source is based on a peer-reviewed academic research paper. While neither source can be guaranteed in terms of usefulness or lack of usefulness, it is more likely that the peer-reviewed academic research paper is a higher quality source and therefore more trustworthy source than that of the social media network post. Consequently, validator 129 may operate not only to validate or invalidate sources but may also score sources 298 using score generating module 120, for instance, to create a confidence score 194 for each of one or more sources 298. In other examples, validator 129 applies higher or lower weights to increase or decrease confidence score 194 for each of one or more sources 298, based on attributes of source 298 (e.g., such as location, whitelist, blacklist, age, etc.).

Score generating module 120 may calculate confidence score 194 or may utilize AI model 130 to output confidence score 194. For instance, score generating module 120 may calculate confidence score 194 based on an evaluation of one or more source quality conditions 132. In other examples, score generating module 120 requests confidence score 194 from AI model 130 which calculates confidence score 194 based on an evaluation of one or more source quality conditions 132. Score generating module 120 may utilize a list of curated source quality conditions 132 (such as those manually configured by a system administrator) or may alternatively request confidence score 194 from AI model 130 and utilize source quality conditions 132 learned by AI model 130 based on a training data set. In other examples, score generating module 120 obtains confidence score 194 from AI model 130 which uses source quality conditions 132 learned by AI model 130 based on a training data set and score generating module 120 applies weightings to increase or decrease confidence score 194 returned from AI model 130 based on a manually curated list of source quality conditions 132. For instance, score generating module 120 may modify confidence score 194 returned from AI model 130 based on any of one or more sources 298 listed on a blacklist, listed on a whitelist, corresponding to a deprecated source, corresponding to a curated list of untrustworthy URLs, corresponding to a curated list of trustworthy URLs, derived from university research, and/or derived from a social media platform or a social media post. Score generating module 120 may calculate confidence score 194 based on one or more sources 298 having inauthentic DNS information or authentic DNS information. For example, DNS information may be determined to be spoofed and thus, inauthentic. In some examples, score generating module 120 calculates confidence score 194 based on a historical age for any of one or more sources 298. In some examples, score generating module 120 calculates confidence score 194 based on a comparison to a golden copy of answers maintained by meta interface layer 128.

Validator 129 may perform one or more validations, including checking to determine whether confidence score 194 provided by score generating module 120 satisfies quality threshold 195 and evaluating sources 298 based on source quality conditions 132. In some examples, validator 129 determines whether confidence score 194 associated with answer 196 fails to satisfy quality threshold 195. Validator 129 may evaluate sources 298 to determine whether any of one or more sources 298 used by LLM 121 to generate answer 196 are invalid. Meta layer interface 128 may utilize determinations of validity or invalidity provided by validator 129 to annotate answer 196 or in certain instances, to indicate that no answer 196 will be provided for a given inquiry 193. For instance, in response to a determination confidence score 194 associated with answer 196 fails to satisfy quality threshold 195 and/or a determination any of one or more sources 298 used by LLM 121 to generate answer 196 are invalid, meta layer interface 128 outputs an indication that computer-generated text 196 output from LLM 121 will not be provided. In at least one alternative example, in response to a determination confidence score 194 associated with answer 196 fails to satisfy quality threshold 195 and/or a determination any of one or more sources 298 used by LLM 121 to generate answer 196 are invalid, meta layer interface 128 discards or filters out computer-generated text 196 from a response provided to computing device 116 in response to inquiry 193. Stated differently, meta layer interface 128 may respond to computing device 116 indicating that a response to the inquiry will not be provided and meta layer interface 128 may optionally indicate reasons why, such as invalid sources or a low-quality answer. In some instances, meta layer interface 128 may further output a recommendation that computing device 116 resubmit inquiry 193, modify and resubmit inquiry 193, or indicate that meta layer interface 128 will resubmit inquiry 193 on behalf of computing device 116. In certain examples, meta layer interface 128 may resubmit inquiry 193 on behalf of computing device 116 without notification to computing device 116.

Meta layer interface 128 may request feedback regarding annotated answers 197 provided to improve future performance of AI model 130. For instance, consider an example where meta layer interface 128 of computing system 105 outputs annotated answer 197 to computing device 116. In response to the output of annotated answer 197 to computing device 116, meta layer interface 128 may obtain user-input 290 from computing device 116 indicating a degree of usefulness of annotated answer 197. For example, meta layer interface 128 may provide annotated answer 197 to the originator of inquiry 193 and responsively prompt the originator of inquiry 193 for user input 290 indicating whether annotated answer 197 provided was helpful or not helpful. Meta layer interface 128 may capture or otherwise obtain user-input 290 and then provide user-input 290 to AI module 130 as input for use with reinforcement learning. For instance, when user-input 290 is associated with answer 196 or annotated answer 197, or both, and provided as input to AI model 130, reinforcement learning by AI model 130 may alter future predictive output by the model to reduce the likelihood of user-input 290 indicating an answer 196 was unhelpful.

Alternatively, user-input 290 may be associated with answer 196 or annotated answer 197, or both, and stored within a training dataset for AI model 130 via which AI model 130 or a future variant of AI model 130 may be trained. The association of user-input 290 indicating whether an answer 196 was helpful or unhelpful may be particularly valuable to a training regime by AI model 130 as such user-input 290 provides known good and known bad examples to AI model 130, thus enabling AI model 130 to implement well known machine learning techniques to improve future predictive output.

Use of annotations within annotated answer 197 may additionally be beneficial to AI model 130 when training future variants as the annotations may provide additional context to AI model 130 regarding why user-input 290 may have indicated any particular annotated answer 197 was either helpful or unhelpful. In certain examples, meta layer interface 128 may additionally provide answers to AI model 130 which failed to satisfy quality threshold 195 and/or were determined to be invalid. For instance, consider answer 196 being evaluated by validator 129 and determined by validator 129 to be invalid due to, for example, use of a low-quality or fictitious source 298. In such an example, the low-quality answer 196 would not be provided back to a user and may be discarded. However, meta layer interface 128 may provide such low-quality answers to AI model 130 as examples known to exhibit low-quality, which AI model 130 may then utilize for future reinforcement learning, or training of a new AI model variant, in an attempt to improve future predictive output provided by AI model 130.

Similarly, meta layer interface 128 may capture or otherwise obtain user-input 290 and then route such user-input 290 to LLM 121 for use with reinforcement learning, providing a feedback loop to LLM 121. Similar to the manner in which known good and known bad examples may be utilized by AI model 130 for improving predictive output, LLM 121 may similarly benefit from use of such user-input 290. Therefore, according to at least one example, meta layer interface 128 may obtain user-input 290 and provide user-input 290 to LLM 121 for use with reinforcement learning. In such an example, meta layer interface 128 may associate user-input 290 is with answer 196 provided by LLM 121, or annotated answer 197 generated by meta layer interface 128, or both, and provide as such input to LLM 121 for use with reinforcement learning and/or future training by LLM 121 as part of a training dataset for LLM 121.

User-input 290 may be obtained as quantitative or qualitative feedback. In some examples, user-input 290 specifies a numerical score for annotated answer 197. In some examples, user-input 290 specifies a non-numerical user-rated assessment for annotated answer 197. For instance, user-input 290 may specify a red color, a yellow color, or a green color for annotated answer 197. For instance, green may correspond to user-input indicating annotated answer 197 was helpful, whereas red may correspond to user-input indicating annotated answer 197 was not helpful, and yellow may indicate ambivalence. In some examples, user-input 290 specifies a thumbs-up indication (e.g., answer 196 provided was helpful) or a thumbs-down indication (e.g., answer 196 was not helpful) for annotated answer 197 via user-input 290. In some examples, user-input 290 specifies a high, medium, or low user-rated confidence for annotated answer 197. In some examples, user-input 290 specifies a Boolean value indicating user-rated usefulness for annotated answer 197.

In some examples, computing system 105 performs validation (e.g., via validator 129) as part of or in addition to obtaining confidence score 194. For instance, in at least one example, validator 129 of meta layer interface 128 validates computer-generated text 196 output (e.g., answer 196) from LLM 121 against one selected source 298 from one or more sources 298 used by LLM 121 to generate answer 196. For instance, validator 129 may validate one selected source 298 based on text obtained from one selected source 298 and compared with computer-generated text 196 output from LLM 121. In another example, validator 129 validates audio content obtained from selected source 298 by comparing the audio content with computer-generated text 196 output from LLM 121. In another example, validator 129 validates video content obtained from one selected source 298 by comparing the video content with computer-generated text 196 output from LLM 121. Consider for instance, one of cited sources 298A, 298B, 298C provided by LLM 121 corresponding to a news-segment posted on a video sharing platform. Regardless of the cited source 298A, 298B, and/or 298C being a video format, source 298 may nevertheless be validated or invalidated based on a comparison of text within answer 196 and video content within the cited video news-segment.

Meta layer interface 128 generates and outputs annotated answers 197 for display. In some examples, meta layer interface 128 annotates answer 196 from LLM 121 to generate annotated answer 197 for output. Computing system 105 may output annotated answer 197 using meta layer interface 128 for display to computing device 116 (e.g., an originating user computing device having submitted original inquiry 193). In some examples, meta layer interface 128 creates annotated answer 197 by annotating answer 196 from LLM 121 with annotations indicating source validity for one or more sources 298 used by LLM 121 to generate at least one part of answer 196. In some examples, meta layer interface 128 creates annotated answer 197 by annotating answer 196 from LLM 121 with annotations indicating source validity for one or more sources 298 used by LLM 121 to generate each of multiple parts of answer 196. In some examples, meta layer interface 128 creates annotated answer 197 by annotating answer 196 from LLM 121 with annotations indicating an overall validity percentage for the multiple parts of answer 196. In some examples, meta layer interface 128 creates annotated answer 197 by annotating answer 196 from LLM 121 with annotations indicating confidence score 194 for at least one of the multiple parts of answer 196. In some examples, meta layer interface 128 creates annotated answer 197 by annotating answer 196 from LLM 121 with annotations indicating an overall confidence score 194 for the multiple parts of answer 196. In some examples, meta layer interface 128 creates annotated answer 197 by annotating answer 196 from LLM 121 with citations and/or links to validated sources 298A, 298B, 298C used by LLM 121 to generate the multiple parts of answer 196.

Meta layer interface 128 may alternatively or additionally annotate answer 196 using information obtained from a user-profile. For instance, meta layer interface 128 may obtain a user-profile associated with computing device 116 having originated inquiry 193. In such an example, meta layer interface 128 updates annotated answer 197, prior to output to computing device 116, with information derived from the user-profile. This may be useful where answer 196 is contextually relevant to a particular user, especially where answer 196 depends on information particular to the user. For example, consider a user that asks the question: “How much does it cost to put a stop payment on a check?” Answer 196 may depend on where the user does their banking, what bank account the check in question was written from, and what benefits or status level the user has with the bank in question. In some examples, meta layer interface 128 may obtain user-profile information and annotate or modify answer 196 provided to limit annotated answer 197 to only those portions of answer 196 which are contextually relevant to the user-profile information. For example, if answer 196 returns a response indicating that a stop payment fee is $10.00 for basic checking account users and free for enhanced checking account users, meta layer interface 128 may annotate or update annotated answer 197 to disclose only the “free” portion of answer 196 where the user-profile indicates the user has the qualifying enhanced checking account.

According to some examples, computing system 105 provides caching services using database system 126. For instance, meta layer interface 128 may determine that inquiry 193 has been previously asked and answer 196 has already been provided, is of high quality or sufficient confidence, and is cached by database 126. In such an example, meta layer interface 128 may obtain the cached answer and return the cached answer in reply to inquiry 193. In other instances where inquiry 193 is submitted to LLM 121 without involvement of computing system 105 or its meta layer interface 128, computing system 128 may obtain answer 196 from LLM 121 in response to inquiry 193 being submitted and retrieve cached annotated answer 197 from database system 126 rather than performing confidence scoring, validation, and re-annotation of answer 196.

According to a particular example, meta layer interface 128 obtains first inquiry 193 and caches, using database system 126, computer-generated text 196 output from LLM 121 as answer 196 to first inquiry 193. In such an example, meta layer interface 128 may only cache answer 196 when confidence score 194 associated with answer 196 satisfies quality threshold 195. In some examples, in response to determining second inquiry 193 received by meta layer interface 128 of computing system 105 matches first inquiry 193 cached using database system 126, meta layer interface 128 obtains answer 196 as previously cached using database system 126. For instance, database system 126 having cached answer 196 for first inquiry 193 may be referenced to obtain answer 196 via which to reply to second inquiry 193 without submitting second inquiry 193 to LLM 121. Alternatively, database system 126 having cached answer 196 for first inquiry 193 may be referenced to obtain annotated answer 197 without re-annotating, re-validating, and/or re-confidence scoring answer 196 before returning annotated answer 197 in reply to second inquiry 193.

FIG. 3 is a block diagram illustrating an example computing system 308 configured to generate source-based confidence scores for LLM output, in accordance with one or more aspects of the present disclosure. Computing system 308 may operate substantially similar to computing system 102 from FIGS. 1A-1B and/or computing system 105 from FIGS. 1A-1B and FIG. 2. As depicted, computing system 308 includes meta layer interface module 328 configured to interface with LLM module 321. Meta layer interface module 328 may obtain computer generated text 196 provided by LLM module 321 as answer 196 in response to an inquiry 193 received by LLM module 321. In such an example, meta layer interface module 328 may evaluate answer 196 for quality and/or validity.

Meta layer interface module 328 may obtain confidence score 194 from score generating module 320. Score generating module may calculate confidence score 194 or obtain confidence score 194 from AI module 330 which generates confidence score as predictive output based at least in part on receiving computer-generated text 196 as input. In some examples, score generating module 320 may apply weightings to predictive output provided by AI module 330 to increase or decrease confidence score 194. In such a way, meta layer interface module 328 may utilize score generating module 320 to provide confidence score 194 which meta layer interface module 328 may compare against quality threshold 195. Meta layer interface module 328 may evaluate whether or not confidence score 194 satisfies quality threshold 195.

Meta layer interface module 328 may evaluate answer 196 provided by LLM module 321 on the basis of validity or invalidity for one or more LLM sources 198 utilized by LLM module 321 in generating answer 196. For instance, meta layer interface module 328 may obtain a determination of validity or invalidity from validation module 329 by requesting validation module 329 to evaluate one or more LLM sources 198 utilized by LLM module 321 to generate answer 196. Validation module 329 may determine validity or invalidity of any of one or more LLM sources 198 by evaluating LLM sources 198 according to source quality conditions 132. Accordingly, the modules of FIG. 3 may perform some or all of the same functions described as being performed by the modules of computing system 102 and 105 of FIGS. 1A-1B and computing system 105 of FIG. 2.

Additionally depicted within computing system 308 is LLM training dataset 322 which provides the information upon which LLM module 321 is trained. LLM module 321 and sub-components may form part of computing system 308 as depicted here or may operate separately within a distinct computing system. When LLM module 321 operates within a distinct computing system, meta layer interface module 328 may be communicably interacted with LLM module 321 over a computer network. For instance, meta layer interface module 328 may interact with LLM module 321 using an Application Programming Interface (API) specially configured for LLM module 321.

In accordance with the disclosed techniques, storage devices 316 may store modules including meta layer interface module 328, score generating module 320, LLM sources, LLM training dataset 322, source quality conditions 132 and computer-generated text (e.g., answer) 196. The stored LLM module 321 may include machine learning models that automatically generate text output based on LLM training dataset 322. Score generating module 320 may produce confidence scores 194 as an evaluation and/or assessment of quality for answer 196 generated by LLM module 321. Confidence score 194 may be compared against quality threshold 195. Meta layer interface module 328 may obtain answers provided by LLM module 321 and subject those answers 196 to validation operations. Meta layer interface module 328 may annotate answers 196 to generate annotated answers 197 which are returned to an originator of inquiry 193 submitted to LLM module 321.

In one example, an exemplary computing system 308 includes one or more storage devices 316 and processing circuitry (e.g., processors 310) in communication with one or more storage devices 316. In such an example, computing system 308, in response to inquiry 193 from computing device 116 submitted to LLM module 321, obtains by meta layer interface module 328, computer-generated text 196 output from LLM module 321 as answer 196 to inquiry 193. In such an example, computing system 308 may determine confidence score 194 in association with answer 196 to inquiry 193 based on an evaluation of one or more LLM sources 198 used by LLM module 321 to generate answer 196. In some examples, computing system 308 determines, by meta layer interface module 328, whether confidence score 194 associated with answer 196 satisfies quality threshold 195. Computing system 308 may annotate answer 196 to generate annotated answer 197 indicating a measure of quality based on the evaluation of one or more LLM sources 198 used. In some examples, computing system 308 outputs, by meta layer interface module 328 to a computing device having originated inquiry 193, annotated answer 197 in response to inquiry 193 when confidence score 194 associated with answer 196 satisfies quality threshold 195.

Score generating module 320 may output probabilities, such as in percentages. Alternatively, each predictive element may produce an individual confidence prediction for each of multiple parts of answer 196 generated by LLM module 321 and the individual confidence predictions may be combined to produce a single probability prediction output as an aggregate confidence score for answer 196. Probabilities as an output may have advantages over hard classifiers such as a prediction accuracy or inaccuracy. For example, probabilities may allow for ranking and comparison.

LLM module 321 may revise parameters of the LLM based on a feedback loop or reinforcement learning by consuming, for example, user-input indicating whether answer 196 was useful or not useful and/or input provided by meta layer interface module 328 providing a confidence score 194 back to LLM module 321 in association with answer 196 provided by LLM module 321. Updating LLM module 321 may be considered a type of post-production model training, such as continual learning, reinforcement learning, or part of a feedback loop.

Computing system 308 may be implemented as any suitable computing system, such as one or more server computers, workstations, mainframes, appliances, cloud computing systems, and/or other computing systems that may be capable of performing operations and/or functions described in accordance with one or more aspects of the present disclosure. In some examples, computing system 308 may comprise a server within a data center, cloud computing system, server farm, and/or server cluster (or portion thereof) that provides services to client devices and other devices or systems. For example, computing system 308 may host or provide access to services provided by one or more applications and/or modules running on computing system 308.

Although computing system 308 of FIG. 3 is illustrated as a stand-alone device, in other examples computing system 308 may be implemented in any of a wide variety of ways and may be implemented using multiple devices and/or systems. In some examples, computing system 308 may be, or may be part of, any component, device, or system that includes a processor or other suitable computing environment for processing information or executing software instructions and that operates in accordance with one or more aspects of the present disclosure. In some examples, computing system 308 may be fully implemented as hardware in one or more devices or logic elements.

In the example of FIG. 3, computing system 308 may include one or more processors 310, one or more communication units 312, one or more input/output devices 314, and one or more storage devices 316. One or more of the devices, modules, storage areas, or other components of computing system 308 may be interconnected to enable inter-component communications (physically, communicatively, and/or operatively). In some examples, such connectivity may be provided by communication channels, a system bus, a network connection, an inter-process communication data structure, or any other method for communicating data. A power source (not shown) may provide power to one or more components of computing system 308. In some examples, the power source may receive power from the primary alternative current (AC) power supply in a commercial building or data center, where some or all of an enterprise network may reside. In other examples, the power source may be or may include a battery.

One or more processors 310 of computing system 308 may implement functionality and/or execute instructions associated with computing system 308 associated with one or more modules illustrated herein and/or described below. One or more processors 310 may be, may be part of, and/or may include processing circuitry that performs operations in accordance with one or more aspects of the present disclosure. In some examples, two or more processors included in processors 310 may each perform different portions of the operations described herein. Examples of processors 310 include microprocessors, application processors, display controllers, auxiliary processors, one or more sensor hubs, and any other hardware configured to function as a processor, a processing unit, or a processing device. Computing system 308 may use one or more processors 310 to perform operations in accordance with one or more aspects of the present disclosure using software, hardware, firmware, or a mixture of hardware, software, and firmware residing in and/or executing at computing system 308.

One or more communication units 312 of computing system 308 may communicate with devices external to computing system 308 by transmitting and/or receiving data, and may operate, in some respects, as both an input device and an output device. In some examples, communication units 312 may communicate with other devices over a network. In other examples, communication units 312 may send and/or receive radio signals on a radio network such as a cellular radio network. In other examples, communication units 312 of computing system 308 may transmit and/or receive satellite signals on a satellite network such as a Global Positioning System (GPS) network. Examples of communication units 312 include a network interface card (e.g., such as an Ethernet card), an optical transceiver, a radio frequency transceiver, a GPS receiver, or any other type of device that can send and/or receive information. Other examples of communication units 312 may include devices capable of communicating over Bluetooth®, GPS, near field communication (NFC), ZigBee, and cellular networks (e.g., 3G, 4G, 5G), and Wi-Fi® radios found in mobile devices as well as Universal Serial Bus (USB) controllers and the like. Such communications may adhere to, implement, or abide by appropriate protocols, including Transmission Control Protocol/Internet Protocol (TCP/IP), Ethernet, Bluetooth, NFC, or other technologies or protocols.

One or more input/output devices 314 may represent any input or output devices of computing system 308 not otherwise separately described herein. One or more input/output devices 314 may generate, receive, and/or process input from any type of device capable of detecting input from a human or machine. One or more input/output devices 314 may generate, present, and/or process output through any type of device capable of producing output.

One or more storage devices 316 within computing system 308 may store information for processing during operation of computing system 308. Storage devices 316 may store program instructions and/or data associated with one or more of the modules described in accordance with one or more aspects of this disclosure. One or more processors 310 and one or more storage devices 316 may provide an operating environment or platform for such modules, which may be implemented as software, but may in some examples include any combination of hardware, firmware, and software. One or more processors 310 may execute instructions and one or more storage devices 316 may store instructions and/or data of one or more modules. The combination of processors 310 and storage devices 316 may retrieve, store, and/or execute the instructions and/or data of one or more applications, modules, or software. Processors 310 and/or storage devices 316 may also be operably coupled to one or more other software and/or hardware components, including, but not limited to, one or more of the components of computing system 308 and/or one or more devices or systems illustrated as being connected to computing system 308.

In some examples, one or more storage devices 316 are temporary memories, meaning that a primary purpose of one or more storage devices is not long-term storage. Storage devices 316 of computing system 308 may be configured for short-term storage of information as volatile memory and therefore not retain stored contents if deactivated. Examples of volatile memories include random access memories (RAM), dynamic random-access memories (DRAM), static random-access memories (SRAM), and other forms of volatile memories known in the art. Storage devices 316, in some examples, also include one or more computer-readable storage media. Storage devices 316 may be configured to store larger amounts of information than volatile memory. Storage devices 316 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories.

Although certain modules, data stores, components, programs, executables, data items, functional units, and/or other items included within one or more storage devices may be illustrated separately, one or more of such items could be combined and operate as a single module, component, program, executable, data item, or functional unit. For example, one or more modules or data stores may be combined or partially combined so that they operate or provide functionality as a single module. Further, one or more modules may interact with and/or operate in conjunction with one another so that, for example, one module acts as a service or an extension of another module. Also, each module, data store, component, program, executable, data item, functional unit, or other item illustrated within a storage device may include multiple components, sub-components, modules, sub-modules, data stores, and/or other components or modules or data stores not illustrated.

Further, each module, data store, component, program, executable, data item, functional unit, or other item illustrated within a storage device may be implemented in various ways. For example, each module, data store, component, program, executable, data item, functional unit, or other item illustrated within a storage device may be implemented as a downloadable or pre-installed application or “app.” In other examples, each module, data store, component, program, executable, data item, functional unit, or other item illustrated within a storage device may be implemented as part of an operating system executed on computing system 308.

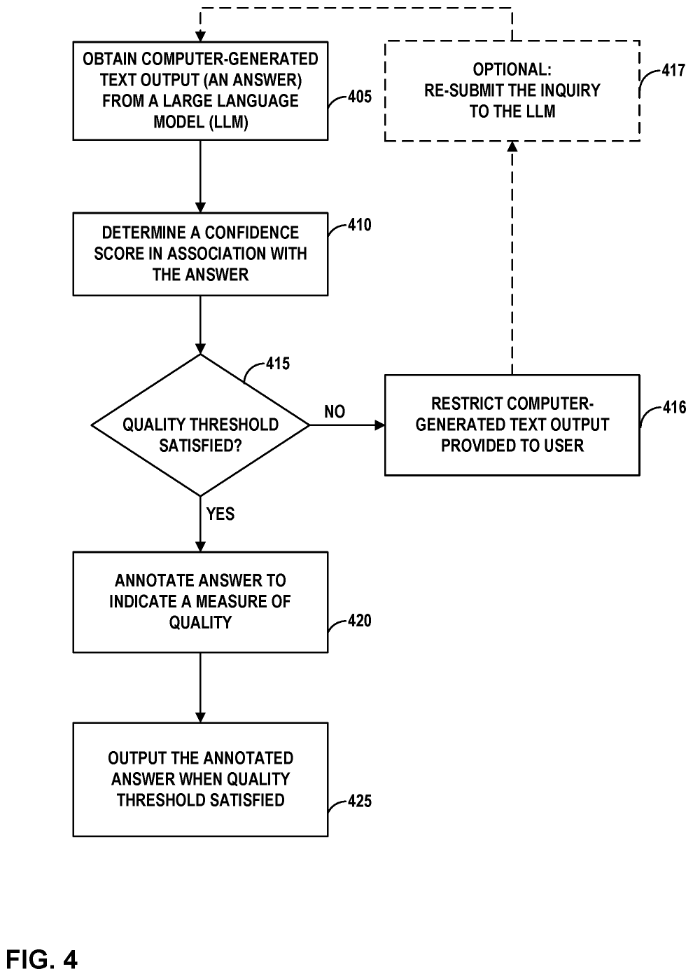

FIG. 4 is a flow chart illustrating an example mode of operation for a computing system to generate source-based confidence scores to annotate output by LLMs, in accordance with techniques of this disclosure. The mode of operation is described with respect to computing system 105 of FIGS. 1A-1B and FIG. 2. In other examples, the mode of operation may be performed by computing system 308 of FIG. 3.

Processing circuitry 199 of computing system 105 obtains computer-generated text (e.g., answer 196) output from LLM 121 (405). For instance, meta layer interface 128 may obtain computer-generated text 196 output from LLM 121 as answer 196 to inquiry 193 submitted by a computing device. Computing system 105 determines confidence score 194 in association with answer 196 (410). For instance, validator 129 may determine confidence score 194 in association with answer 196 to inquiry 193 based on an evaluation of one or more sources 198 used by LLM 121 to generate answer 196.

Computer system 105 may determine whether quality threshold 195 is satisfied (415). For instance, validator 129 of computing system 105 may determine whether confidence score 194 associated with answer 196 satisfies quality threshold 195. If confidence score 194 satisfies quality threshold 195 (“YES” branch of 415), meta layer interface 128 annotates answer 196 to indicate a measure of quality (420). For instance, based on confidence score 194 associated with answer 196 satisfying quality threshold 195, meta layer interface 128 may generate annotated answer 197 including answer 196 and an indication of quality based on the evaluation of one or more sources 198 used by LLM 121 to generate answer 196. According to such an example, computing system 105 may output annotated answer 197 when quality threshold 195 is satisfied (425). For instance, meta layer interface 128 may output, to computing device 116, annotated answer 197 in response to inquiry 193.

Conversely, if confidence score 194 fails to satisfy quality threshold 195 (“NO” branch of 415), meta layer interface 128 may restrict computer-generated text 196 output (e.g., restrict answer 196 by LLM 121) provided to the user (416). In such an example, meta layer interface 128 may discard answer 196 based on answer 196 failing to satisfy quality threshold 195 output providing answer 196 in response to inquiry 193. Optionally, meta layer interface 128 may re-submit inquiry 193 to LLM 121 (417). For example, meta layer interface 128 may re-submit inquiry 193 on behalf of a computing device 116 having submitted inquiry 193 to trigger the generation of a new answer 196 from LLM 121. Meta layer interface 128 may then check the new answer 196 from LLM 121 to determine if new answer 196 satisfies quality threshold 195. Similar to above, new answer 196 may be annotated with an indication of quality and output to a computing device 116 having originated inquiry 193.

According to another example, in response to determining whether one or more sources 198 used by LLM 121 to generate answer 196 are valid sources, meta layer interface 128 may provide feedback to LLM 121 indicating validity or invalidity for each of one or more sources 198.

In yet another example, in response to obtaining computer-generated text 196 from LLM 121 as answer 196 to inquiry 193 submitted by computing device 116, meta layer interface 128 may evaluate one or more sources 198 used by LLM 121 to generate answer 196. In such an example, meta layer interface 128 may determine whether one or more sources 198 used by LLM 121 to generate answer 196 are valid based on evaluating one or more sources 198.

According to another example, meta layer interface 128 may determine whether one or more sources 198 used by LLM 121 to generate answer 196 are valid sources based on evaluating one or more source quality conditions 132. For instance, such source quality conditions may include any of one or more sources 198 listed on a blacklist of sources 198. Source quality conditions 132 may include any of one or more sources 198 listed on a whitelist of sources. Source quality conditions 132 may include any of one or more sources 198 corresponding to deprecated sources 198. Source quality conditions 132 may include any of one or more sources 198 corresponding to a curated list of untrustworthy URLs. Source quality conditions 132 may include any of one or more sources 198 corresponding to a curated list of trustworthy URLs. Source quality conditions 132 may include any of one or more sources 198 derived from university research. Source quality conditions 132 may include any of one or more sources 198 derived from a social media platform. Source quality conditions 132 may include any of one or more sources 198 corresponding to a social media post. Source quality conditions 132 may include presence of inauthentic DNS information for any of one or more sources 198. Source quality conditions 132 may include presence of inauthentic URL information for any of one or more sources 198. Source quality conditions 132 may include evaluation of a historical age for any of one or more sources 198, such as source 198 being outdated. Source quality conditions 132 may include a comparison to a golden copy of answers. For instance, a collection of human curated answers may be incorporated into a golden copy of answers against which other sources may be compared.

According to another example, based on confidence score 194 associated with answer 196 failing to satisfy quality threshold 195 or a determination any of one or more sources 198 used by LLM 121 to generate answer 196 are invalid, meta layer interface 128 may discard answer 196 and re-submit inquiry 193 previously submitted by computing device 116 to LLM 121 on behalf of computing device 116. In such an example, meta layer interface 128 may obtain new computer-generated text 196 output from LLM 121 as new answer 196 to inquiry 193. Based on new confidence score 194 associated with the new answer satisfying quality threshold 195, meta layer interface 128 may generate new annotated answer 197 and output new annotated answer 197 for display to computing device 116 in response to inquiry 193.

In yet another example, meta layer interface 128 includes caching inquiries and associated answers. For instance, in an example where inquiry 193 is first inquiry 193, meta layer interface 128 may receive first inquiry 193 from computing device 116, submit first inquiry 193 to LLM 121, and cache, using database system 126, first inquiry 193 and computer-generated text 196 output from LLM 121 as answer 196 to first inquiry 193 when confidence score 194 associated with answer 196 satisfies quality threshold 195. Continuing with such an example, meta layer interface 128 may further receive second inquiry 193 from a second computing device. In such an example, in response to determining that second inquiry 193 matches first inquiry 193 cached using database system 126, meta layer interface 128 may obtain answer 196 to first inquiry 193 cached using database system 126 as answer 196 to second inquiry 193 without submitting second inquiry 193 to LLM 121. Continuing with such an example, meta layer interface 128 may then output for display to the second computing device, answer 196 in response to second inquiry 193.

For processes, apparatuses, and other examples or illustrations described herein, including in any flowcharts or flow diagrams, certain operations, acts, steps, or events included in any of the techniques described herein can be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can include RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A system comprising:
one or more storage devices; and
processing circuitry in communication with the one or more storage devices, the processing circuitry configured to:
obtain computer-generated text output from a Large Language Model (LLM) as an answer to an inquiry submitted by a computing device;
determine a confidence score in association with the answer to the inquiry based on an evaluation of one or more sources used by the LLM to generate the answer;
determine whether the confidence score associated with the answer satisfies a quality threshold; and
based on the confidence score associated with the answer satisfying the quality threshold:
generate an annotated answer including the answer and an indication of quality based on the evaluation of the one or more sources used by the LLM to generate the answer; and
output, to the computing device, the annotated answer in response to the inquiry.

2. The system of claim 1, wherein the processing circuitry is configured to, in response to a determination whether the one or more sources used by the LLM to generate the answer are valid sources, provide feedback to the LLM indicating validity or invalidity for each of the one or more sources.

3. The system of claim 1, wherein the processing circuitry is configured to:
in response to obtainment of the computer-generated text from the LLM as the answer to the inquiry submitted by the computing device, evaluate the one or more sources used by the LLM to generate the answer; and
determine whether the one or more sources used by the LLM to generate the answer are valid based on the evaluation of the one or more sources.

4. The system of claim 1, wherein the processing circuitry is configured to determine whether the one or more sources used by the LLM to generate the answer are valid sources based on the evaluation of one or more source quality conditions, including:
any of the one or more sources listed on a blacklist of sources;
any of the one or more sources listed on a whitelist of sources;
any of the one or more sources corresponding to a deprecated source;
any of the one or more sources corresponding to a curated list of untrustworthy URLs;
any of the one or more sources corresponding to a curated list of trustworthy URLs;
any of the one or more sources derived from university research;
any of the one or more sources derived from a social media platform;
any of the one or more sources corresponding to a social media post;
inauthentic DNS information for any of the one or more sources;
inauthentic URL information for any of the one or more sources;
a historical age for any of the one or more sources; or
a comparison to a golden copy of answers maintained by the meta interface layer.

5. The system of claim 1, wherein the processing circuitry is configured to, based on the confidence score associated with the answer failing to satisfy the quality threshold or a determination any of the one or more sources used by the LLM to generate the answer are invalid, output, to the computing device, a notification indicating that an answer to the inquiry will not be provided.

6. The system of claim 1, wherein the processing circuitry is configured to, based on the confidence score associated with the answer failing to satisfy the quality threshold or a determination any of the one or more sources used by the LLM to generate the answer are invalid:
discard the answer;
re-submit the inquiry previously submitted by the computing device to the LLM on behalf of the computing device;
obtain new computer-generated text output from the LLM as a new answer to the inquiry; and
based on a new confidence score associated with the new answer satisfying the quality threshold:
generate a new annotated answer; and
output, to the computing device, the new annotated answer in response to the inquiry.

7. The system of claim 1, wherein the processing circuitry is configured to:
obtain, from the computing device, user-input indicating a degree of usefulness of the annotated answer; and
provide, to the LLM, the user-input indicating the degree of usefulness of the annotated answer, wherein the user-input specifies at least one of:
a numerical score for the annotated answer;
a non-numerical user-rated assessment for the annotated answer;
a red color, a yellow color, or a green color for the annotated answer;
a thumbs-up or a thumbs-down indication for the annotated answer;
a high, medium, or low user-rated confidence for the annotated answer; or
a Boolean value indicating user-rated usefulness for the annotated answer.

8. The system of claim 1, wherein to determine the confidence score, the processing circuitry is configured to:
provide as a first input to an artificial intelligence (AI) model, a golden copy of answers;
provide as a second input to the AI model, the computer-generated text output from the LLM as the answer to the inquiry; and
obtain from the AI model, the confidence score indicating probability the answer is accurate.

9. The system of claim 1, wherein to determine the confidence score, the processing circuitry is configured to validate the computer-generated text output from the LLM against a selected source from the one or more sources used by the LLM to generate the answer based on one or more of:
text obtained from the selected source and compared with the computer-generated text output from the LLM;
audio content obtained from the selected source and compared with the computer-generated text output from the LLM; or
video content obtained from the selected source and compared with the computer-generated text output from the LLM.

10. The system of claim 1, wherein, to generate the annotated answer, the processing circuitry is configured to annotate the answer from the LLM with one or more of:
annotations indicating source validity for the one or more sources used by the LLM to generate at least one part of the answer;
annotations indicating source validity for the one or more sources used by the LLM to generate each of multiple parts of the answer;
annotations indicating an overall validity percentage for the multiple parts of the answer;
annotations indicating the confidence score for at least one of the multiple parts of the answer;
annotations indicating an overall confidence score for the multiple parts of the answer; or
one or more of citations or links to validated sources used by the LLM to generate the multiple parts of the answer.

11. The system of claim 1, wherein the processing circuitry is configured to:
obtain a user-profile associated with the computing device having originated the inquiry; and
update the annotated answer, prior to output to the computing device, with information derived from the user-profile.

12. The system of claim 1, wherein the processing circuitry is configured to:
receive the inquiry from the computing device; and
submit the inquiry to the LLM.

13. The system of claim 12, wherein the inquiry is a first inquiry, and wherein the processing circuitry is configured to:
cache, using a database system, the first inquiry and the computer-generated text output from the LLM as the answer to the first inquiry when the confidence score associated with the answer satisfies the quality threshold;
receive a second inquiry from a second computing device;
in response to a determination that the second inquiry matches the first inquiry cached using the database system, obtain the answer to the first inquiry cached using the database system as the answer to the second inquiry without submitting the second inquiry to the LLM; and
output the answer in response to the second inquiry to the second computing device.

14. A method comprising:
obtaining, by processing circuitry of a computing system, computer-generated text output from a Large Language Model (LLM) as an answer to an inquiry submitted by a computing device;
determining, by the processing circuitry, a confidence score in association with the answer to the inquiry based on an evaluation of one or more sources used by the LLM to generate the answer;
determining, by the processing circuitry, whether the confidence score associated with the answer satisfies a quality threshold; and
based on the confidence score associated with the answer satisfying the quality threshold:
generating, by the processing circuitry, an annotated answer including the answer and an indication of quality based on the evaluation of the one or more sources used by the LLM to generate the answer; and
outputting, by the processing circuitry and for display to the computing device, the annotated answer in response to the inquiry.

15. The method of claim 14, further comprising, in response to determining whether the one or more sources used by the LLM to generate the answer are valid sources, providing feedback to the LLM indicating validity or invalidity for each of the one or more sources.

16. The method of claim 14, further comprising:
in response to obtaining the computer-generated text from the LLM as the answer to the inquiry submitted by the computing device, evaluating the one or more sources used by the LLM to generate the answer; and
determining whether the one or more sources used by the LLM to generate the answer are valid based on evaluating the one or more sources.

17. The method of claim 14, further comprising determining, by the processing circuitry, whether the one or more sources used by the LLM to generate the answer are valid sources based on evaluating of one or more source quality conditions, including:
any of the one or more sources listed on a blacklist of sources;
any of the one or more sources listed on a whitelist of sources;
any of the one or more sources corresponding to a deprecated source;
any of the one or more sources corresponding to a curated list of untrustworthy URLs;
any of the one or more sources corresponding to a curated list of trustworthy URLs;
any of the one or more sources derived from university research;
any of the one or more sources derived from a social media platform;
any of the one or more sources corresponding to a social media post;
inauthentic DNS information for any of the one or more sources;
inauthentic URL information for any of the one or more sources;
a historical age for any of the one or more sources; or
a comparison to a golden copy of answers maintained by the meta interface layer.

18. The method of claim 14, further comprising, based on the confidence score associated with the answer failing to satisfy the quality threshold or a determination any of the one or more sources used by the LLM to generate the answer are invalid:
discarding the answer;
re-submitting the inquiry previously submitted by the computing device to the LLM on behalf of the computing device;
obtaining new computer-generated text output from the LLM as a new answer to the inquiry; and
based on a new confidence score associated with the new answer satisfying the quality threshold, generating a new annotated answer and outputting, by the processing circuitry and for display to the computing device, the new annotated answer in response to the inquiry.

19. The method of claim 14, wherein the inquiry is a first inquiry, and wherein the method further comprises:
receiving, by the processing circuitry, the first inquiry from the computing device;
submitting the first inquiry to the LLM;
caching, using a database system, the first inquiry and the computer-generated text output from the LLM as the answer to the first inquiry when the confidence score associated with the answer satisfies the quality threshold;
receiving a second inquiry from a second computing device;
in response to determining that the second inquiry matches the first inquiry cached using the database system, obtaining the answer to the first inquiry cached using the database system as the answer to the second inquiry without submitting the second inquiry to the LLM; and
outputting, by the processing circuitry and for display to the second computing device, the answer in response to the second inquiry.

20. Computer-readable storage media comprising instructions that, when executed, configure processing circuitry to:
obtain computer-generated text output from a Large Language Model (LLM) as an answer to an inquiry submitted by a computing device;
determine a confidence score in association with the answer to the inquiry based on an evaluation of one or more sources used by the LLM to generate the answer;
determine whether the confidence score associated with the answer satisfies a quality threshold; and
based on the confidence score associated with the answer satisfying the quality threshold:
generate an annotated answer including the answer and an indication of quality based on the evaluation of the one or more sources used by the LLM to generate the answer; and
output, to the computing device, the annotated answer in response to the inquiry.
